(19) United States
(12) Patent Application Publication
(10) Pub. No.: US 2007/0106589 A1
(43) Pub. Date: May 10, 2007

(54) Method for determining an optimal and tailored lifetime income and death benefit package

(76) Inventor: Felix Schirripa, Colts Neck, NJ (US)

Correspondence Address: PEPE & HAZARD, LLP, 225 ASYLUM ST., HARTFORD, CT, 06103, US

(21) Appl. No.: 11/271,605

(22) Filed: Nov. 10, 2005

(51) Int. Cl. G06Q 40/00

(52) U.S. Cl. 705/36 R

(57) ABSTRACT

An annuitant is able to select and optimize the allocation of a premium for insurance coverage between lifetime income benefits for the annuitant and death benefits to the annuitant's beneficiaries. A set of underwriting factors is established to provide the insurance coverage and value both the lifetime income to the annuitant and the death benefits payable to the beneficiaries. These factors include anticipated investment returns on the premium paid for the coverage, and which are used for both the income and death benefit components of the coverage. The annuitant uses these to derive a combination of lifetime income for the annuitant and death benefits available to the annuitant's beneficiaries. To do so, the annuitant inputs personal information including minimum dollar death benefit acceptable to the annuitant if the annuitant's death occurred immediately after the issue of the coverage, and the minimum death benefit to the designee if the annuitant's death occurs on or after some future date. This generates a solution showing the dollar death benefits payable in a lump sum to the beneficiaries at various possible dates of death into the future, as well as the corresponding lifetime income available for the annuitant.

### BACKGROUND OF THE INVENTION

The present invention relates to a method for allowing an annuitant to select and optimize the allocation of a premium for insurance coverage between lifetime income benefits for the annuitant and death benefits to the annuitant's beneficiaries.

Many baby-boomers understand the emerging healthcare crisis. Few, however, fully appreciate another potentially significant crisis—the risk of outliving the assets they need for a comfortable retirement. Retirees tend to downplay or ignore “longevity” risk and, therefore, make inadequate provisions in the construction of their retirement income portfolios.

Yet, according to published mortality tables, a 65 year old male retiree in good health has a 25% probability of living to at least age 92. If he is married, there is a 25% probability that he or his spouse will live to age 97. As medical advances continue, the odds of living longer will only improve and add more risk to a retiree's income portfolio.

Longevity risk, i.e., running out of assets for a comfortable retirement, should be of concern to baby-boomers that rely on assets from 401(k) savings plans and cash balance arrangements. The traditional defined benefit pension plan providing fixed payments for life has been a good source of longevity protection for those retirees fortunate to have such an employee benefit. These traditional pension plans, however, are quickly becoming dinosaurs. In fact, there has been a strong trend away from defined benefit plans, shifting more longevity risk to the individual.

Individuals can buy protection against longevity risk. For example, retirees can buy an insurance product called a life annuity. The life annuity guarantees fixed payments for life (but provides no death benefit) in exchange for an upfront premium. The annuity product has been around for a very long time; however, the vast majority (98%) of retirees do not use it.

The life annuity has many different names. It is common to refer to it as a payout annuity, income annuity, or immediate annuity. The basic product structure is essentially the same. In exchange for a specific premium, the insurance company guarantees lifetime payments. The frequency of payments can vary, for example, monthly, quarterly, or annually. Nevertheless, the buyer (also referred to as the annuitant, or retiree, or owner) always receives guaranteed payments for life.

Most retirees have the perception that the benefit of buying an income annuity comes at significant cost. This is so because, once the life annuity is purchased, the retiree “forfeits” the entire premium. It can take more than 15 years before the retiree could expect to reach the “breakeven” point relative to other fixed investments. For many retirees, forfeiting the full premium and “betting” to live at least 15 years to “breakeven” appears foolish.

The design of the life annuity is part of the reason retirees do not buy it. Its design actually hides the value it offers. This is because many retirees incorrectly measure its value by oversimplifying the risk/reward tradeoffs of two options—buying vs. not buying the annuity. And this simplified analysis often leads them to the wrong decision (i.e., not to buy the annuity).

The risk of forfeiture is the tradeoff the buyer accepts in exchange for an income stream that he cannot outlive. Insurers have tried to overcome the forfeiture objection by offering life annuities with term certain periods, or issuing joint life annuities, or offering a cash refund feature.

In a “term certain” income annuity, the annuitant's beneficiary receives the income stream for the “certain” period, commonly 10 or 20 years. In a joint life annuity, payments continue for the life of the last survivor. These forms of annuity contracts help reduce the buyer's concern about the forfeiture risk. Today, it is common for insurers to offer annuitants a “menu” of annuity forms (e.g., 10, or 20 year certain, and joint & survivor).

Annuities are insurance contracts that provide one or more payments during the life of one or more individuals (referred to as “annuitants”). The payments may be contingent upon one or more annuitants being alive (a life-contingent annuity) or may be non-life-contingent. Payments are typically made for so long as the individual lives (a life annuity) or, although rare, for a fixed period of years during an individual's life (an n-year temporary life annuity). The “n-year” temporary life annuity is virtually non-existent. For example, a 1-year temporary life annuity provides payments for 1-year and only if the annuitant is alive.

In all cases, the payments may begin immediately upon purchase of the annuity contract or they may be deferred for a period of time. Also, annuity payments may become due at the beginning of payment intervals (an annuity due), or at the end of the payment intervals (an annuity immediate). Annuities that offer predefined and scheduled payments are also known as “income annuities” or “payout annuities”.

Annuities are important financial security products that have a major role in a variety of contexts, including life/disability insurance, and group and individual pension programs. An annuity may be used to provide periodic payments to an individual throughout retirement.

A life annuity provides a guarantee that its owner (i.e., annuitant, retiree) will not outlive his or her payout. This type of guarantee is not available with non-annuity products such as mutual funds and certificates of deposit (CDs). (Note that the terms “owner,” “annuitant,” “annuity purchaser,” or “investor” need not refer to the same person. Herein, the terms will be used interchangeably with the meaning being understood by context.)

Payout annuities can provide fixed, variable, or a combination of fixed and variable benefit payments. A fixed annuity guarantees certain payments in amounts determined at the time of contract issuance. A variable annuity will provide payments that vary with the investment performance of the assets that underlie the annuity contract. These assets are typically segregated in a separate account of the insurer. Finally, a combination annuity pays amounts that are partly fixed and partly variable.

Both fixed and variable annuities can guarantee scheduled payments for life or for a term of years. A fixed annuity offers the security of guaranteed, pre-defined periodic payments. A variable annuity also guarantees periodic payments, but the amount of each payment will vary with investment performance of the underlying assets.

The following is a list of types of annuity contracts available in the market. The list is long and could be confusing to most buyers. The end result of the confusion is that retirees shy away from the product they need.
Life annuity—Income payments for life and no payments to a beneficiary.
5 years certain and life annuity—Income for life and, if death happens during the first 5 years, the beneficiary continues to receive payments until the end of the 5^{th} year of the contract.
10 (or 15, or 20) years certain and life annuity—Income for life and, if death happens in the first 10 (or 15, or 20) years, the beneficiary continues to receive payments until the end of the 10^{th} (or 15^{th}, or 20^{th}) contract year.
Joint life annuity—Income payments during joint lifetime. Income is not reduced when either annuitant dies. No payments to beneficiary.
10 (or 20) year certain and joint life annuity. Same as Joint life annuity, but payments continue to beneficiary to the end of the 10^{th} (or 20^{th}) contract year (if both annuitants die before then).
50% Joint & Survivor annuity—Income payments for life. Payments drop 50% on the death of primary annuitant. No payments to beneficiary.
Cash Refund and life annuity—Income payments for life. Beneficiary receives death benefit equal to premium paid less total income payments made to annuitant.

The menu of income annuities is long, however, it is also too restrictive to fit individual needs. In addition, a “menu” approach falls short of what retirees really want—optimal income and optimal death benefits. Another negative of a “menu” is that the annuitant has no control over the design of the contract death benefits. The annuitant either accepts one of the choices on the menu, for example, 10 year certain and life, or simply does not buy. There is no flexibility to customize the contract, let alone help the individual optimize the lifetime income and achieve death benefits that are consistent with the forfeiture risk the retiree is prepared to assume.

Many individuals do not buy income annuities because they are uncomfortable with the forfeiture risk and the difficulty in translating the insurer's product menu in terms of the “forfeiture risk” they are prepared to accept. Yet this is the only product that can offer lifetime income protection. For the most part, it goes unused simply because it does not offer other more attractive income/death benefit design alternatives.

The alternative, not buying the income annuity, can be very risky for the retiree. Unfortunately, this option “feels” right for many years. It is only when the retiree lives too long and continues to draw down assets from their retirement portfolio that the decision to avoid annuities may begin to feel foolish as the retirement portfolio runs out of assets.

In both of these extreme alternatives, a correct assessment of longevity risk requires the retiree to pick accurate mortality and investment assumptions. Unfortunately, selecting the right assumptions is extremely difficult, even for experts, and therefore makes a true assessment of longevity risk virtually impossible for the retiree to measure.

Yet, neither of these buying alternatives actually fits what many retirees really want from their retirement assets—maximum lifetime income and maximum death benefits.

It is the object of the present invention to provide a novel method for providing insurance coverage which yields optimal retirement income and optimal death benefits, by, in effect, allowing the annuitant to “dial” the level of death benefits (up or down) and customize the income/bequest plan.

It is also an object to provide such a novel method which enables the prospective annuitant to evaluate various options to determine a preferred combination of income and death benefits.

Another object of the present invention is to present the value that the annuity offers in a manner which is easier to see and understand.

### SUMMARY OF THE INVENTION

It has now been found that the foregoing and related objects may be readily attained in a method of allowing an annuitant to select and optimize the allocation of a premium for insurance coverage between lifetime income benefits for the annuitant and death benefits to the annuitant's beneficiaries. The method establishes a set of underwriting factors to provide insurance coverage and value both the lifetime income to the annuitant and the death benefits payable to the beneficiaries. These factors include, but are not limited to, mortality rates, anticipated investment returns on the premium paid for the coverage, and administrative expenses, and these factors are used for both the income and death benefit components of the coverage.

To derive the combination of lifetime income for the annuitant and death benefits available to the annuitant's beneficiaries, the annuitant inputs information selected from the group comprising date of birth or age of the annuitant, gender, premium amount, minimum dollar death benefit acceptable to the annuitant if the annuitant's death occurred immediately after the issue of the coverage, and the minimum death benefit to the designee if the annuitant's death occurs on or after some future date. These factors generate a solution showing the dollar death benefits payable in a lump sum to the beneficiaries at various possible dates of death into the future, as well as the corresponding lifetime income available for the annuitant.

If so desired, the above steps may be repeated until a preferred balance between income and death benefits is obtained, and the premium to be paid for the coverage may be changed to achieve the desired balance. The goal is the issuance of insurance coverage using the factors and benefits selected by the annuitant and which specifies the lifetime income and death benefit values inside the annuity and guarantees those payments to the annuitant and the death benefits to the beneficiaries. Also the death benefits are dollar denominated (and not “term certain” periods) to further simplify the explanations to the buyer.

The amount of the income benefit may be adjusted upwardly or downwardly at defined points during the term of the coverage and the death benefit will be concurrently reduced or increased, and the premium paid may also be changed.

As used herein, the term “annuitant” in terms of the execution of the novel methods of the present invention includes the insured, the insurer, financial consultants, and agents and brokers.

### BRIEF DESCRIPTION OF THE ATTACHED DRAWINGS

FIG. 1 is a simplified flow chart of the steps in the method of the present invention; and

FIG. 2 is a diagrammatic comparison of the current method for evaluating and obtaining an annuity and the method for doing so pursuant to the present invention.

### DETAILED DESCRIPTION OF THE ILLUSTRATED EMBODIMENT

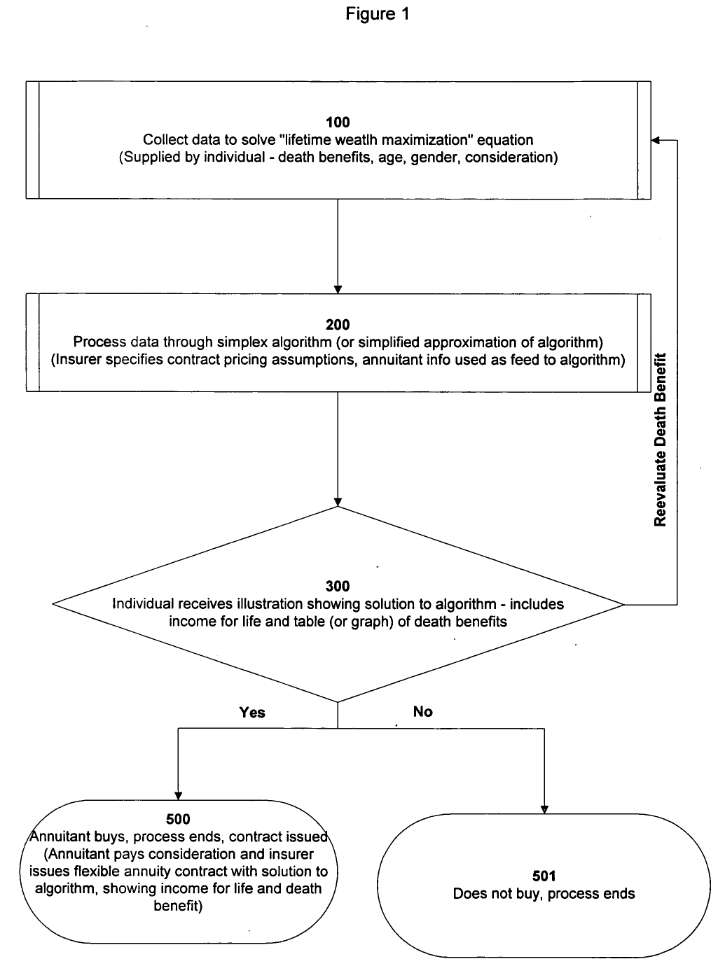

The present invention is described more fully hereinafter with reference to FIG. 1 that shows embodiments of the present invention. These embodiments are provided to illustrate the scope of the present invention.

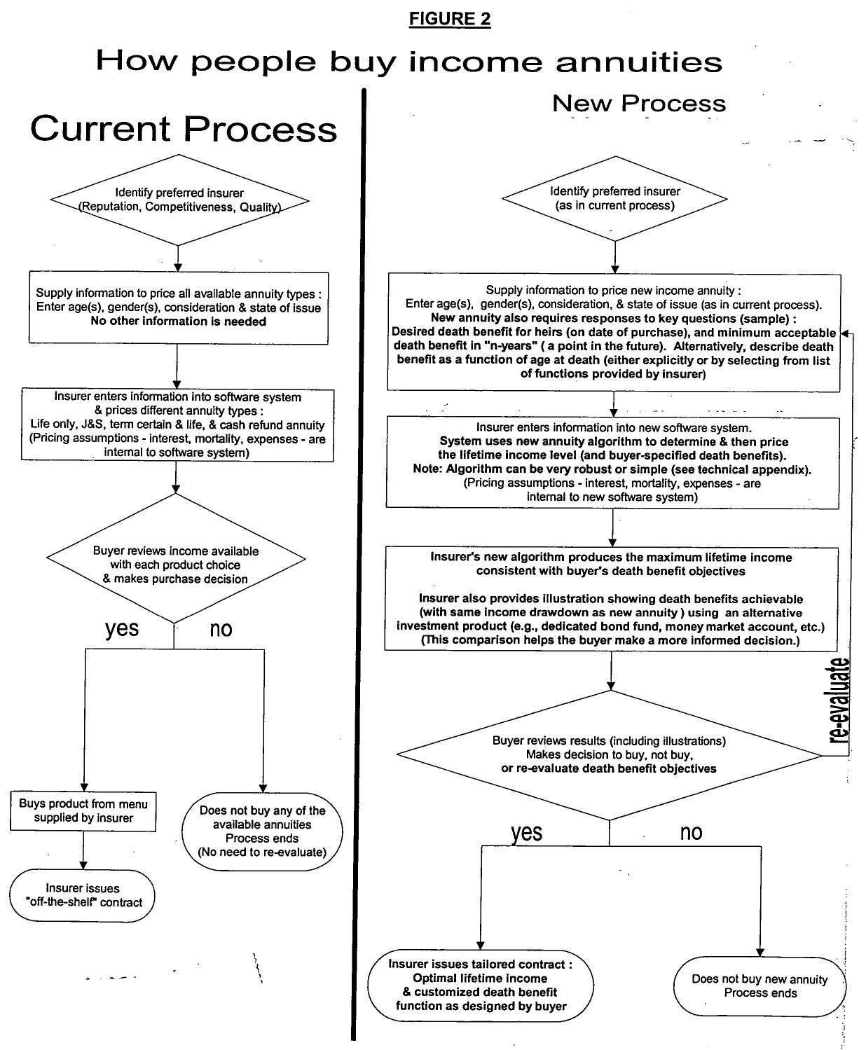

FIG. 2 comprises the novel method of the present invention for obtaining optimal coverage with the present method for purchasing an annuity.

According to the present invention, a computer implemented method implements the new flexible income annuity to provide for optimal lifetime income and optimal death benefits for heirs. In an embodiment of the present invention, the simplex algorithm solves the “lifetime wealth maximization” equation and that solution is used to customize the flexible annuity contract.

FIG. 1 is an exemplary flow chart for implementing the flexible income annuity. The method begins in step 100 where the individual(s) provides the system the consideration, age(s), gender(s), and desired death benefit. In an embodiment of the present invention, the death benefit can be described in enormous detail (i.e., amount of benefit at each point in time in the future) or very simply (e.g., death benefit if death is today, and death benefit if death is in, say, 20 years).

In an embodiment of the present invention, the insurer processes the input from the individual and solves the “lifetime wealth maximization” equation (see Method A) using the simplex method, or uses an approximate solution to that equation (see Method B). In either case, in step 300, the individual sees the solution offered by the new flexible annuity.

The individuals now have three choices. They could buy the solution and proceed to step 400. Or, they could decide to not buy and proceed to step 401. Or, they could re-evaluate the death benefit input (i.e., feed in lower or higher death benefits in step 100) and see the new solution. At this point, the process is iterative (back to step 100) or it ends with a buy/no buy decision.

In one embodiment of the present invention, the annuitant specifies the desired death benefits and the algorithm delivers the optimal lifetime income.

In another embodiment of the present invention, the annuitant may re-specify the desired death benefits (either higher or lower) and the prior solution is re-evaluated to deliver the new optimal lifetime income. In another embodiment of the present invention, the annuitant may continue to refine the desired death benefit function until the combination of income and death benefits is what is wanted.

In another embodiment of the present invention, the buyer has full control over the death benefit design. In another embodiment of the present invention, the death benefit is expressed in “dollars” paid at death instead of “period certain” terms.

In an embodiment of the present invention, the novel process uses linear programming techniques to solve the annuitant's dilemma of wanting to optimize both death benefits for heirs and income for life. In the present invention (Method B), the information collected from the annuitant is kept to a minimum (relying merely on age, gender, minimum death benefit at contract issue and minimum death benefit on and after a selected period, e.g., 20 years). Keeping the required information from the annuitant to a minimum, increases utility and focuses the annuitant on the primary goal—an optimal income and bequest plan tailored to fit his needs—with minimal effort.

In the practice of the method of the present invention, simple formulas may be used. These formulas are solved using the simplex algorithm (with user's constraints regarding death benefits) to optimize death benefit for heirs and income for life.

The simplex algorithm is well known to mathematicians and actuaries and is described as a fundamental technique for solution of linear programming problems. Detailed presentations on the simplex algorithm and linear programming are found in a number of texts including:
(1) Chvatal, Vasek, Linear Programming, W. H. Freeman and Company, 1983.
(2) Bixby, Robert E., “Implementing the Simplex Method: The Initial Basis”, ORSA Journal on Computing, Vol. 4, No. 3, 1992.
(3) Andersen, Erling D. and Knud D. Andersen, “Presolving in Linear Programming”, Mathematical Programming, Vol. 71, pp. 221-245, 1995.

To facilitate the solution, the formulas assume fixed interest rates and ignore loads required by the insurer. The expense and risk loads are ignored in this description because there are a vast number of ways to charge the annuitant. These range from a percent of premium, use of conservative mortality assumptions, fund charges, charges on income payments, and others. The list is too long and the method of charging is both confusing and not relevant to the methods and processes described here.

### Method A

Standard actuarial notation is used in this explanation of the method and also in the discussion of the other methods. Also, for ease of writing algorithms, the following simplifying assumptions are made (recognizing that “extensions” are fairly straightforward once the basic process and methods are understood):
1. The retiree (or individual) is age x.
2. Extension to joint and multiple life arrangements is straightforward, and not illustrated.
3. Time periods, t, are measured in years (and extensions to, say, monthly are obvious).
4. The first payment to the retiree occurs at time t=1, but deferred payments (for example, at time t=k>1) are readily possible and apparent (as well as payments starting at 0<t<1).
5. Annual interest is fixed and constant at rate i (and the discount rate is given by the formula v=1/(1+i)). In reality, interest rates are a vector and may vary from period to period.
6. The retiree is assumed to pay the annuity premium at time t=0.
7. We assume the initial premium equals F₀ and the retiree wants minimum death benefits at time k equal to MDBₖ.
8. Mortality rates are assumed to follow a pre-defined table (with or without anti-selection factors) selected by the insurer.
9. For simplicity, expenses and risk charges are ignored. They may be reflected in a number of ways (for example, lower interest assumption, lower mortality rates, lower death benefits and/or income payments by a factor, and/or lower the initial consideration to cover a portion of or all of the future charges).

Borrowing from standard actuarial science, we note that 1=(1+i)Aₓ+iaₓ. (Here Aₓ represents the cost of whole life insurance paying $1 at the end of the year of death for an individual age x at issue, and aₓ represents the cost of a life annuity paying $1 for life at the end of each year.) This formula states that, in exchange for $1 of premium, the insurer can afford to pay interest on the $1 at the end of each year of life, and on death pay interest plus the original $1 to the beneficiary.

It is also noted that 1/i=v+v²+v³+ . . . +vⁿ+ . . .

With these observations and simplifications, the following expression describes the value of the income payment stream available to the retiree for life (evaluated at time t=0). The expression allows for the calculation of the total fixed annual income, P_{T}, to the retiree given an initial consideration, or premium, of F₀ at time t=0.
P_{T}=P+nQ+R
where P=(F₀−MDB₀)/aₓ, and
R=iMDBₙ and Q is derived using the formulas below, reconfigured as follows:
F₀=Paₓ+Q(A₀ₙ+A₁ₙ+ . . . +Aₖₙ)+Q(t₁₁v aₓ₊₁+t₁₂v²aₓ₊₂+ . . . +t₁ₙⁿαₓ₊ₙ)+R/i
Where the various factors are defined as follows:
A₀ₙ=t₀₁v+t₀₂v²+ . . . +t₀ₙvⁿ (non-life contingent payments)
A₁ₙ=t₁₁a_{x:1}+t₁₂va_{x+1:1}+ . . . +t₁₍ₙ₋₁₎vⁿ⁻¹a_{x+n-1:1} where the a_{z:1} represents the cost of a one year term life contingent payment (made only if the retiree is alive at time 1).
A₂ₙ=t₂₁a_{x:2}+t₂₂va_{x+1:2}+ . . . +t₂₍ₙ₋₂₎vⁿ⁻²a_{x+n-2:2} where the a_{z:2} represent the cost of 2-year term life contingent payments (made only if alive at time payment is due)
Aₖₙ=tₖ₁a_{x:k}+tₖ₂va_{x+1:k}+ . . . +tₖ₍ₙ₋ₖ₎v^{n-k}a_{x+n-k:k} where the a_{z:k} represent the cost of k-year term life contingent payments (made only if alive at time payment is due).
Note that the Aⱼₖ essentially represent the present cost of a series of term-life contingent annuities.

With these definitions and mathematical expressions out of the way, the algorithm can be solved to optimize payments for the life of the retiree (or joint lives) while also optimizing the value of the funds available to the retiree's heirs or estate.

The retiree needs to specify (or have specified for him or her) the minimum acceptable death benefit at, say, time t=0, 1, 2, . . . , n, . . . with values of MDBₜ less than or equal to Fₜ.

In addition, for the algorithm to produce level payments of, for example, $1 per year, the following constraints must apply:

Σtⱼ₁=1 where the sum travels from j=0 to j=k.

t₁₁+Σtⱼ₂=1 where the sum goes from j=0 to j=t and t₁₁ represents the portion of the payment from life annuities purchased at t=0 and committed to at time t=1.

Σt₁ⱼ+Σtⱼₙ=1 where the first sum travels from j=1 to n and the second travels from j=0 to n

And, Σtᵢⱼ=1 traveling from j=1 to n.

Further,

0≦t₁₁≦t₁₂≦. . . ≦t₁₍ₙ₋₁₎≦t₁ₙ≦1

And, tᵢⱼ≧0 for all i, j

And,

MDB₀≦F₀,

MDB₁≦F₁,

MDBₙ≦Fₙ

Where Fₘ can be derived from the previous formulas appropriately accumulated for interest at rate “i” and, of course, dropping the pieces of funds committed to life contingent annuities prior to time m and the pieces that represent non-life contingent payments already made to the retiree prior to time m. These pieces are no longer available to the beneficiary since they are being used (or have been used) to support the life contingent payments to the retiree.

Now, using the simplex algorithm, we can solve for the maximum level of death benefits available at time t, we derive the tᵢⱼ for all “i”, “j” such that

F₀ is as previously defined, and
F₁=Q/v (A₁ₙ+ . . . +Aₖₙ)+Q/v (t₁₂v²aₓ₊₂+t₁₃v³aₓ₊₃+ . . . +t₁ₙvⁿaₓ₊ₙ)+R/I,
F2=Q/v² (A₂ₙ+ . . . +Aₖₙ)+Q/v² (t₁₃v³aₓ₊₃+t₁₄v⁴aₓ₊₄+ . . . +t₁ₙvⁿaₓ₊ₙ)+R/I,
Etc.

Further, if the retiree does not wish to take the time to feed all the required constraints and minimum acceptable death benefits, excellent results are achieved by using the following simplified input (constraints) and ignoring the use of n-year term life contingent annuities. The simplified input could be as follows:
1. F₀ (the premium or consideration)
2. MDB₀ (or could default to MDB₀=F₀ to simplify further)
3. MDBₙ (to avoid specifying both MDB and n, could default to n=20 for example)
   Then, an obvious solution that satisfies all the constraints (and simplifies the operation of the new “income and estate” annuity) is as follows:
   P=(F₀−MDB₀)/aₓ
   Q=(MDB₀−MDBₙ)/{[1/n]{((n)v+(n−1)v²+ . . . +(1)vⁿ)+(vaₓ₊₁+v²aₓ₊₂+ . . . +vⁿaₓ₊ₙ)}}
   R=iMDBₙ
   Total lifetime payments then equal:
   P_{T}=P+nQ+R

Alternatively, the retiree can specify the level of desired payments and the algorithm can be solved for possible funds required at t=0 (F₀).

While the formulas suggest that all future payments are fixed and guaranteed for life, in fact, the algorithm can just as readily work with variable annuity contract structures (with either a fixed “AIR” or a floating “AIR”). In this case, the interest assumption “i” is treated as the “AIR” and once the initial payments are derived at time t=0 as P_{T0}, future payments follow the progression:
P_{Tk}=P_{T(k-1)}{(1+rₖ₋₁₎/(1+i)}
where the rj represents the actual investment return for period j.

The algorithm has applications beyond retirees wishing to “optimize lifetime wealth” and creating a “personal retirement program”. The same process can be used in any situation where an individual (or individuals) wish to juggle competing priorities (income and death benefit, for example). Therefore, applications to defined benefit arrangements are obvious, as are those to structured settlements, disability income, long term care, and other mixes of insurable interests.

### Method B

Previously, there has been described, in Method A, a process for helping individuals optimize their lifetime wealth by introducing the “lifetime wealth equation” and deriving the solution set based on the simplex algorithm. For some insurers and regulators, the process may be cumbersome to apply in practice.

A simpler approach is available, and this section develops and describes the necessary formulas, algorithms and processes.

Here, the optimal solution is “unbundled” from before and “repackaged” using the cost components of two very familiar protection products—life insurance and life annuities.

In essence, we look to extend the basic concept that life insurance and income annuities issued to the same individuals can form a “perfect” mortality hedge. Indeed, as described earlier, we know that:
1=(1+i) Aₓ+iaₓ

From this very simple and elegant formula, once we recognize the optimal solution, and know the retiree's minimum acceptable death benefits are MDB₀, MDB₁, . . . , MDBₙ for years n and later, it is possible to derive P_{T}, the total annual lifetime income as follows (retaining all assumptions and notation from Method A):
F₀=Σ(v^{k} MDB_{k k}pₓ A_{x+k:1}+vⁿ MDB_{n n}pₓ Aₓ₊ₙ+Paₓ

Where the summation goes from k=0 to (n−1) and A_{z:1} represents the cost of a 1-year term life insurance policy issued to an individual at age z., and ₖpₓ represents the probability of a person age x surviving to age x+k.

If further simplicity is required, this expression can be reduced to a form that requires the retiree to “feed” only the initial death benefit (MDB₀) and the ultimate death benefit (MDBₙ). In this simplistic form, the intermediate values would be developed using an automated process that saves the retiree the burden of having to feed all the intermediate values. One such automated process is to generate the value of MDBₜ at time t and to grade down to the ultimate death benefit value (i.e., MDBₙ) such that MDBₜ equals:
MDBₙ+Lₜ−Nₜ
Where Lₜ=Max {0, 2*(MDB₀−DDBₙ)*(1−t/n)}
And, Nₜ=Max {0, [(MDB₀−MDBₙ)*(1−v^{(n-t)})]/(1−vⁿ)}
Where v=1/(1+i) and i=interest rate less a deduction of, say, 1%.

Further, one can take a step back from the details and view the process from a high level as the mathematical sum of two contracts—life insurance and annuities. But, now both the life insurance and annuity components of the contract use the same pricing mortality assumption. In fact, this is a major difference. If the retiree tried to “replicate” the math by separately buying the pieces (one piece with life insurance, the other with the annuity), the two purchases would not be efficient. In this case, the insurance component would use life insurance mortality (and may require medical underwriting) and loads. The other would use life annuity mortality and annuity loads. The end result is a higher cost (lower income level or lower death benefits) than our solution. Nevertheless, taking this high level view, we can re-write the formulas as: F₀=D A+P_{T} a. (where “D” represents the vector of death benefits, “A” the insurance, “P_{T}” the total payment and “a” the life income annuity).

Note that both “A” and “a” could be replaced by other forms of insurance contracts (for example, joint life, last to die, 10-year certain and life).

With this general view, it is possible to treat “A” and “a” as fixed and/or variable and vice-versa.

Recalibrating the optimal income and death benefit inside the new annuity is also fairly straightforward. The process requires the insurer to “cash out” the death benefit portion and use that “cash out” value to provide additional lifetime income.

The “cash out” value would be treated as the consideration (or funds available) in the optimal lifetime wealth equation. With that as a given (supplied by the insurer), the annuitant would go through the process of re-defining the new death benefits now desired. The algorithm (see Method A or B) would then lead to the recalibrated optimal lifetime income solution.

The algorithm and process in Method A solve a “lifetime wealth maximization” equation. The annuitant is permitted to set constraints on the minimum acceptable survivor values (i.e., death benefits) at various points in time. Also, the simplex method is used because it provides an optimal solution to mathematical problems with competing, but equally critical, objectives. In this case, the competing objectives are: maximum income for the annuitant, and maximum death benefit for heirs.

In essence, the new algorithm described hereinbefore permits the annuitant to customize the flexible income annuity to optimize the lifetime income and death benefits. It, in fact, simplifies the entire process of retirement income planning. It is a simple, customer-friendly, way to deliver a personalized retirement program that optimizes the lifetime wealth available from a predefined pool of assets. It allows the individual to find the perfect “balance” between two conflicting priorities inside one product, recognizing personal goals.

However, for the vast majority of retirees, the method could be viewed as cumbersome and tedious. In an embodiment of the present invention, the optimal solution to the “lifetime wealth equation” is approximated to vastly simplify the inputs required while capturing much, if not all, of the value in the “exact” solution. In one embodiment of the present invention, the simplified solution is mathematically treated as the sum of the optimal death benefit using the appropriate/optimal term life insurance costs to deliver the death benefit and the optimal income is treated as a “balancing” item. This simplification, interestingly, also simplifies the process of integrating and pricing the new flexible annuity for the insurer.

However, by mathematically bundling the solution through the use of two “common” products inside the flexible annuity, Method B illustrates the methods and processes that will lead to more flexibility. Now, for example, it is possible to provide the individual with the ability to purchase death benefit protection that is either fixed or variable. Similarly, the annuitant can purchase income protection that is either fixed or variable (regardless of how the death benefit protection operates). The payments to the beneficiary impact the level of income for the individual, but the form (i.e., fixed vs. variable) does not have as much bearing.

Now both the life insurance and annuity components of the contract use the same pricing mortality assumption. In fact, this is a major difference. If the retiree tried to “replicate” the math by separately buying the pieces (one piece with life insurance, the other with the annuity), the two purchases would not be efficient. In this case, the insurance component would use life insurance mortality (and may require medical underwriting) and loads. The other would use life annuity mortality and annuity loads. The end result is a higher cost (lower income level or lower death benefits) than the solution obtained by the methods of the present invention.

It should be noted that, while the focus of this new flexible payout annuity is to improve the retirement planning and protection process for retirees, applications to other areas are readily possible. In fact, many retirement plans may want to offer this new financial product (in place of Joint and Survivor annuities, for example). Or, structured settlement situations that currently employ term certain and life or cash refund annuity designs, may prefer the flexibility offered by this new process and product. Also, contracts that offer the option to buy annuities using some normal form (e.g., 10 year certain and life, J&S, etc.), may want to offer it as a better, neater, simpler, and more attractive option. These are merely some examples since the list is quite extensive and not germane to this patent filing.

As explained earlier, neither buying nor, the alternative, not buying income annuities fits what the retiree household really wants—a way to maximize the best of these alternatives while minimizing the worst from these alternatives. This can be done if the retiree household is prepared to accept the new flexible income annuity as the ideal compromise (or balanced) solution. The balance is, in effect, to accept the best possible solution (by solving the simplex algorithm) that maximizes the benefits of no annuities in the early years and yet maximizes the benefits of all annuities in the later years. This strategy avoids the big bets implicit in both buying annuities and never buying annuities. It is akin to “self-insuring” the longevity risk.

In one embodiment of the present invention, by designing the annuity to provide for the optimal lifetime wealth solution, the annuitant can feel comfortable that the money deposited into the contract will be allocated in an optimal fashion. In an embodiment of the present invention, the new flexible annuity gives the buyer control to juggle between conflicting priorities of maximum income and maximum death benefits

The comfort of achieving optimal lifetime income payments and residual value for heirs is what the embodiments of the present invention deliver for retirees. These embodiments illustrate that life annuities can be redesigned to deliver what retirees want—optimal income for themselves and optimal residual assets for their heirs. Without these refinements, life annuities may continue to be underutilized by retirees. If so, both the retirees and the beneficiaries are likely to be worse off.

In a sense, the new annuity design is akin to “balanced funds”. Instead of balancing stocks and bonds for an optimal risk/reward target, the new annuity design allows individuals to balance between income and death benefits for an optimal (and personalized) retirement program that fits their unique needs. And, like balanced funds, the “mix” of income and death benefits can later be recalibrated by permitting the individual to “trade” death benefits for income and vice-versa.

Thus, it can be seen from the foregoing detailed description that the novel methods of the present invention allow the annuitant to select and optimize the allocation of a premium for insurance coverage between lifetime income benefits for the annuitant and death benefits to the annuitant's beneficiaries. The method is easily adopted to different species of retirement and death coverages and computer programs may be made available to the prospective annuitant or the evaluations may be made by the insurer or its brokers and agents.

Having thus described the invention, what is claimed is:

1. In a method for allowing an annuitant to select and optimize the allocation of a premium for insurance coverage between lifetime income benefits for the annuitant and death benefits to the annuitant's beneficiaries, the steps comprising:
(a) establishing a set of underwriting factors to provide insurance coverage and value both the lifetime income to the annuitant and the death benefits payable to the beneficiaries including, but not limited to, mortality rates, anticipated investment returns on the premium paid for the coverage, and administrative expenses, said set of factors being used for both the income and death benefit components of the coverage;
(b) using said underwriting factors to derive a combination of lifetime income for the annuitant and death benefits available to the annuitant's beneficiaries by inputting the information selected from the group comprising date of birth or age of the annuitant, gender, premium payment, minimum dollar death benefit acceptable to the annuitant if the annuitant's death occurred immediately after the issue of the coverage, and the minimum death benefit to the designee if the annuitant's death occurs on or after some future date; and
(c) generating a solution showing the dollar death benefits payable in a lump sum to the beneficiaries at various possible dates of death into the future, as well as the corresponding lifetime income available for the annuitant.

2. The method for allowing an annuitant to select and optimize the allocation of a premium between lifetime benefits and death benefits in accordance with claim 1 including repeating steps (b) and (c) until a preferred balance between income and death benefits is obtained.

3. The method for allowing an annuitant to select and optimize the allocation of a premium between lifetime benefits and death benefits in accordance with claim 1 including the step of issuing insurance coverage using the factors and benefits selected by the annuitant.

4. The method for allowing an annuitant to select and optimize the allocation of a premium between lifetime benefits and death benefits in accordance with claim 3 wherein said coverage specifies the lifetime income and death benefit values inside the annuity and guaranteeing those payments to the annuitant and the death benefits to the beneficiaries.

5. The method for allowing an annuitant to select and optimize the allocation of a premium between lifetime benefits and death benefits in accordance with claim 1 including the step of adjusting the amount of the retirement income benefit upwardly at defined points during the term of the coverage and concurrently reducing the death benefit.

6. The method for allowing an annuitant to select and optimize the allocation of a premium between lifetime benefits and death benefits in accordance with claim 1 wherein the annuitant may change the premium allocated for the coverages and thereby the benefits.
